(19) United States
(12) Patent Application Publication
(10) Pub. No.: US 2014/0113547 A1
(43) Pub. Date: Apr. 24, 2014

(54) APPARATUS FOR SPATIAL FILTERING USING TRANSMISSION DELAY DIFFERENCE OF SIGNALS AND METHOD FOR THE SAME

(71) Applicant: Electronics & Telecommunications Research Institute, Daejeon (KR)

(72) Inventors: Byung Jae KWAK, Daejeon (KR); Young Hoon KIM, Daejeon (KR)

(21) Appl. No.: 14/057,288

(22) Filed: Oct. 18, 2013

(30) Foreign Application Priority Data
Oct. 18, 2012 (KR) 10-2012-0116043
Oct. 18, 2013 (KR) 10-2013-0124414

(51) Int. Cl. H04W 76/02

(52) U.S. Cl. CPC H04W 76/023
USPC 455/39

(57) ABSTRACT

Provided are an apparatus for spatial filtering using transmission delay difference of signals and method for the same. A scanning apparatus may comprise a first signal generating part generating a first signal, a second signal generating part generating a second signal, and a response receiving part receiving a response message based on arrival time difference between the first signal and the second signal from the counterpart apparatus. Therefore, the scanning apparatus can discriminate apparatuses positioned in a specific direction and apparatuses positioned in other directions by using arrival time difference of received signals.

### CLAIM FOR PRIORITY

This application claims priority to Korean Patent Application No. 10-2012-0116043, filed on Oct. 18, 2012 and No. 10-2013-0124414 filed on Oct. 18, 2013 in the Korean Intellectual Property Office (KIPO), the entire contents of which are hereby incorporated by reference.

### BACKGROUND

1. Technical Field

Example embodiments of the present invention relate in general to a method of spatial filtering and apparatus using the same, and more specifically to a method of spatial filtering, which can discriminate neighbor apparatuses positioned in a specific direction and neighbor apparatuses positioned in other directions by using arrival time difference of received signals, and apparatus using the same.

2. Related Art

Since interest on device-to-device (D2D) communications, in other words, direct communication between devices increases, a study on D2D communications technologies becomes active and a standardization of D2D communications protocol is taking place nowadays.

One of the problems, which are frequently focused upon in the D2D communications, is how to find a peer device to be desired among a plurality of neighbor devices and to establish a link with the found peer apparatus.

For example, supposing a situation that a device (device A) and other device (device B), which support D2D communications, communicate with each other, firstly, the device A finds all neighbor devices by scanning, secondly, the device B with which is desired to communicate is selected from a list of all the neighbor devices scanned, thirdly, the device A and device B establish a link for communication via association and authentication procedures, etc.

At this time, when there are many neighbor devices, the list of all the neighbor devices scanned may be very long and it may be a cumbersome task for user to select a desired device from such the long list. If scanning devices only in the specific direction (in other words, in the direction where the desired target device is located) instead of scanning all neighbor devices by using spatial filtering technologies is possible, time consumed for scanning may be reduced drastically and the burden of the cumbersome task, selecting the desired device from the long list of scanned devices, may be alleviated.

### SUMMARY

Accordingly, example embodiments of the present invention are provided to substantially obviate one or more problems due to limitations and disadvantages of the related art.

Example embodiments of the present invention provide a scanning apparatus for scanning apparatus positioned in the desired direction by using spatial filtering based on a plurality of received signals.

Example embodiments of the present invention also provide a responding apparatus of finding a direction of itself from a scanning apparatus by using spatial filtering based on a plurality of received signals from the scanning apparatus and providing a response message to the scanning apparatus.

In some example embodiments, a scanning apparatus includes: a first signal generating part generating a first signal; a second signal generating part generating a second signal, wherein the second signal generating part is positioned in a generation distance from the first signal generating part; and a response receiving part receiving a response message based on arrival time difference between the first signal and the second signal in the counterpart apparatus from the counterpart apparatus.

Here, the first signal and the second signal may be acoustic signals.

Here, the first signal and the second signal may be generated with a predetermined transmission time difference.

Also, the first signal may be a signal orthogonal to the second signal.

Also, the predetermined transmission time difference may be configured to include a predetermined amount of time shared by the scanning apparatus and the counterpart apparatus.

Also, the predetermined transmission time difference may be configured based on a position of the counterpart apparatus from which the scanning apparatus desires to receive the response message.

Here, the response message from the counterpart apparatus may be received when the arrival time difference between the first signal and the second signal in the counterpart apparatus is less than a predetermined value.

Here, the response message from the counterpart apparatus may comprise a value based on the arrival time difference between the first signal and the second signal and information identifying the counterpart apparatus.

In other example embodiments, a responding apparatus, which responds by using spatial filtering based on a plurality of received signals, includes: a signal receiving part receiving a first signal and a second signal from a scanning apparatus, wherein the second signal is generated in a predetermined distance from a generation position of the first signal; a response generating part generating a response message based on arrival time difference between the first signal and the second signal; and a response transmitting part transmitting the response message to the scanning apparatus.

Here, the first signal and the second signal may be acoustic signals.

Here, the first signal and the second signal may be generated with a predetermined transmission time difference.

Also, the first signal may be a signal orthogonal to the second signal.

Also, the predetermined transmission time difference may be configured to include a predetermined amount of time shared by the scanning apparatus and the responding apparatus.

Also, the predetermined transmission time difference may be configured based on a position of the responding apparatus from which the scanning apparatus desires to receive the response message.

Also, the response message may be generated and transmitted when the arrival time difference between the first signal and the second signal in the responding apparatus is less than a predetermined value.

Also, the response message to the scanning apparatus may comprise a value based on the arrival time difference between the first signal and the second signal and information identifying the responding apparatus.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram to explain a method of scanning neighbor apparatuses by using spatial filtering according to the present invention;

FIG. 2 is a conceptual diagram to explain a method of scanning neighbor apparatuses by using spatial filtering according to the present invention;

FIG. 3 is a graph to explain signals received in the first responding apparatus;

FIG. 4 is a graph to explain signals received in the second responding apparatus;

FIG. 5 is a graph to explain signals received in the third responding apparatus;

FIG. 6 is a conceptual diagram to explain an another example method of scanning neighbor apparatuses by using spatial filtering according to the present invention;

FIG. 7 is a block diagram to explain a composition of scanning apparatus using spatial filtering according to the present invention; and

FIG. 8 is a block diagram to explain a composition of responding apparatus using spatial filtering according to the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternative forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, numbers, steps, operations, elements, and/or components, but do not preclude the presence or addition of one or more other features, numbers, steps, operations, elements, components, and/or groups thereof.

Hereinafter, preferred embodiments of the present invention will be described in detail with reference to the accompanying drawings. In the drawings and description, elements that appear in more than one drawing and/or elements that are mentioned in more than one place in the description are always denoted by the same respective reference numerals and are not described in detail more than once.

Hereinafter, a first signal and a second signal generated from an apparatus performing spatial filtering in order to scan neighbor apparatuses are supposed to be acoustic signals for a preferred example embodiment. However, electromagnetic wave signals may be used as the first signal and the second signal.

Also, an apparatus scanning a specific apparatus (desired apparatus or target apparatus) in a specific direction (in other words, in the direction where the desired apparatus exists) among neighbor apparatuses is defined as ‘scanning apparatus’ and the neighbor apparatuses which are to be scanned by ‘scanning apparatus’ is defined as ‘responding apparatus’, which includes the apparatuses existing in the specific direction or apparatuses in other directions. On the other hand, ‘scanning apparatus’ and ‘responding apparatus’ are names defined by a role of apparatus in spatial filtering method according to the present invention. Thus, an apparatus may have both functions—a scanning function of ‘scanning apparatus’ and a responding function of ‘responding apparatus’. For example, a responding apparatus also may be implemented to perform a function of ‘scanning apparatus’ and a ‘scanning apparatus’ also may be implemented to perform a function of ‘responding apparatus’.

Spatial Filtering Method According to the Present Invention

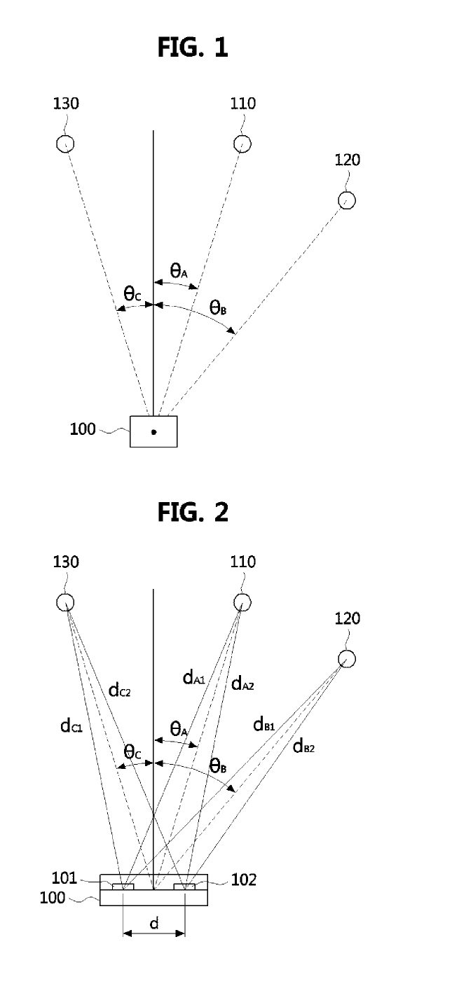

FIG. 1 is a conceptual diagram to explain a method of scanning neighbor apparatuses by using spatial filtering according to the present invention.

Referring to FIG. 1, an environment where a scanning apparatus 100 exists and three neighbor responding apparatuses 110, 120, 130 exist near the scanning apparatus is supposed.

When a direction oriented by the scanning apparatus 100, which is scanning neighbor apparatuses, is supposed to be 0°, the first responding apparatus 110 is positioned in a direction of θ_{A}, the second responding apparatus 120 is positioned in a direction of θ_{B} and the third responding apparatus 130 is positioned in a direction of θ_{C}.

We suppose the first responding apparatus 110, the second responding apparatus 120 and the third responding apparatus 130 are supposed not to know their directions from the scanning apparatus. Also, the scanning apparatus 100 is supposed to have a purpose of selecting the first responding apparatus positioned in the direction of θ_{A}. In other words, the first responding apparatus 110 is supposed to be a target apparatus of the scanning apparatus 100.

The scanning apparatus 100 comprises more than two signal generating parts capable of generating signal in order to achieve an effect of spatial filtering according to the present invention.

For example, the scanning apparatus 100 may comprise a first signal generating part (101 of FIG. 2) and a second signal generating part (102 of FIG. 2) and the first signal generating part 101 and the second signal generating part 102 may be transducers when the first signal and the second signal are acoustic signals. The first signal generating part 101 is equipped in predetermined generation distance d from the second signal generating part 102 in the scanning apparatus 100 (Referring to FIG. 2).

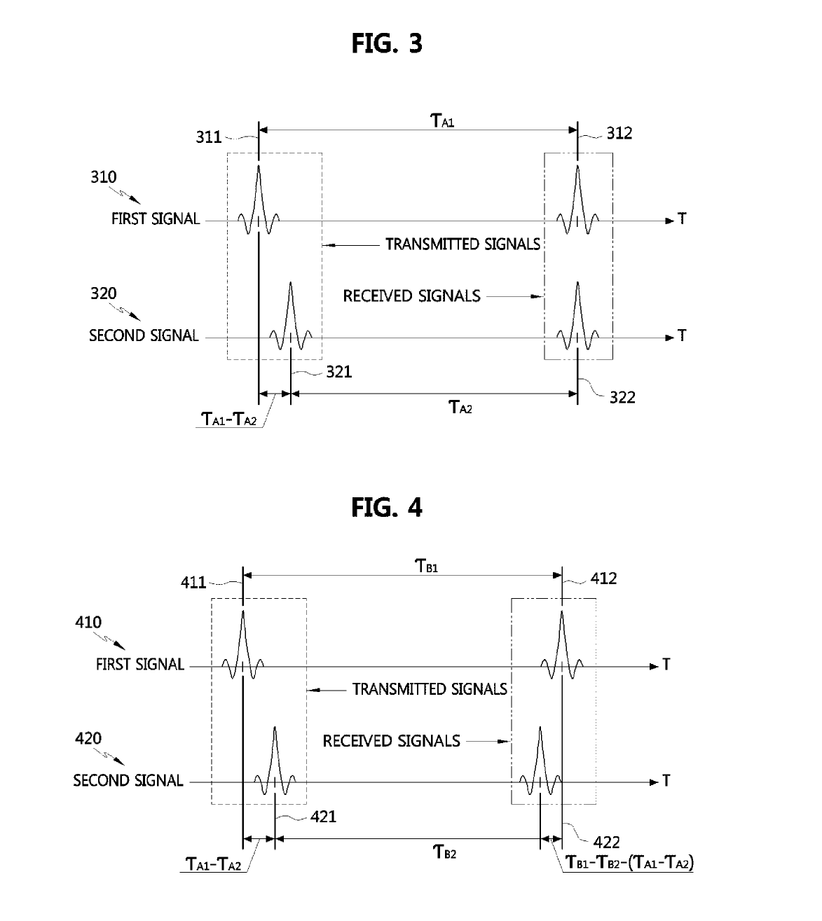

On the other hand, for the first and second signal used for measuring transmission to delay difference, signal suitable for measuring its arrival time can be used, but the signal format is not restricted to any specific structure. For example, as shown later in FIG. 3 to FIG. 6, a pulse signal may be used as the first signal and the second signal. Also, a chirp signal as well as a signal obtained by modulating a specific sequence can be used as the first signal and the second signal.

Hereinafter, although an example embodiment using two signal generating parts is described to explain the present invention, any extended embodiments using more than two signal generating parts are possible in the scope of the present invention.

Also, hereinafter, although a spatial filtering on a horizontal direction from a perspective of the scanning apparatus 100 is explained, a spatial filtering on a vertical direction or any angular direction from a perspective of the scanning apparatus 100 is possible if arrangement of the first signal generating part 101 and the second signal generating part 102 changes correspondingly.

FIG. 2 is a conceptual diagram to explain an example method of scanning neighbor apparatuses by using spatial filtering according to the present invention.

Referring to FIG. 2, positions of the scanning apparatus 100, the responding apparatuses 110, 120, 130 are supposed as follows. In addition, a distance between the first signal generating part 101 and the second signal generating part 102 is supposed as follows.

The distance between the first signal generating part 101 and the second signal generating part 102 is supposed to be d.

Also, the first responding apparatus 110, the target apparatus which the scanning apparatus 100 desires to select, is supposed to be located in the direction of θ_{A}>0.

Also, the second responding apparatus 120 and the third responding apparatus 130 which the scanning apparatus 100 desires not to select are supposed to be located in the directions of θ_{B}>0 and θ_{C}>0 respectively.

Under the above-mentioned assumption, it is an objective of the present invention that only the first responding apparatus 110 located in the direction which the scanning apparatus desires to select responds to the scanning apparatus 100 and the second and the third responding apparatus 120, 130 located in the direction which the scanning apparatus does not desire to select do not respond to the scanning apparatus when the scanning apparatus transmits the first signal and the second signal. In other example embodiment, the scanning apparatus may be configured to determine direction of each responding apparatus based on a response message received from the each responding apparatus, which is explained later.

Hereinafter, the method is explained in view of the scanning apparatus scanning neighbor apparatuses before anything else.

In FIG. 2, a distance between the first signal generating part 101 of the scanning apparatus 100 and the first responding apparatus 110 is supposed to be d_{A1}, a distance between the second signal generating part 102 of the scanning apparatus 100 and the first responding apparatus 110 is supposed to be d_{A2}.

When the distance between the signal generating parts 101 and 102 is supposed to be negligibly smaller than d_{A1} and d_{A2}, a relation of them can be approximated in an equation 1 as follows.

d_{A1}−d_{A2}≈d sin θ_{A}. [Equation 11]

When a transmission velocity of the first and second signals is supposed to be v, an arrival time difference of the first signal and the second signal in the first responding apparatus 110 from the signal generating parts can be approximated in an equation 2 as follows.

$${τ}_{A 1} - {τ}_{A 2} \approx \frac{d sin {θ}_{A}}{v} . \qquad [ Equation 2 ]$$

Here, τ_{A1} represents the amount of time for the first signal to arrive in the first responding apparatus 110 from the first signal generating part 101, and τ_{A2} represents the amount of time for the second signal to arrive in the first responding apparatus 110 from the second signal generating part 102.

The scanning apparatus 100 is configured to transmit the second signal by the second signal generating part 102 a predetermined time later after transmitting the first signal by the first signal generating part 101. Here, the transmission time difference of two signals is set to τ_{A1}−τ_{A2} in consideration of an arrival time difference of two signals in the first responding apparatus 110 located in the desired direction based on the equation 2. Therefore, the first signal and the second signal arrive at the first responding apparatus 110 almost simultaneously.

Hereinafter, the method is explained in view of the responding apparatuses 110, 120 and 130 which respond to the scanning apparatus based on the first signal and the second signal transmitted from the scanning apparatus 100.

Firstly, FIG. 3 is a graph to explain signals received in the first responding apparatus.

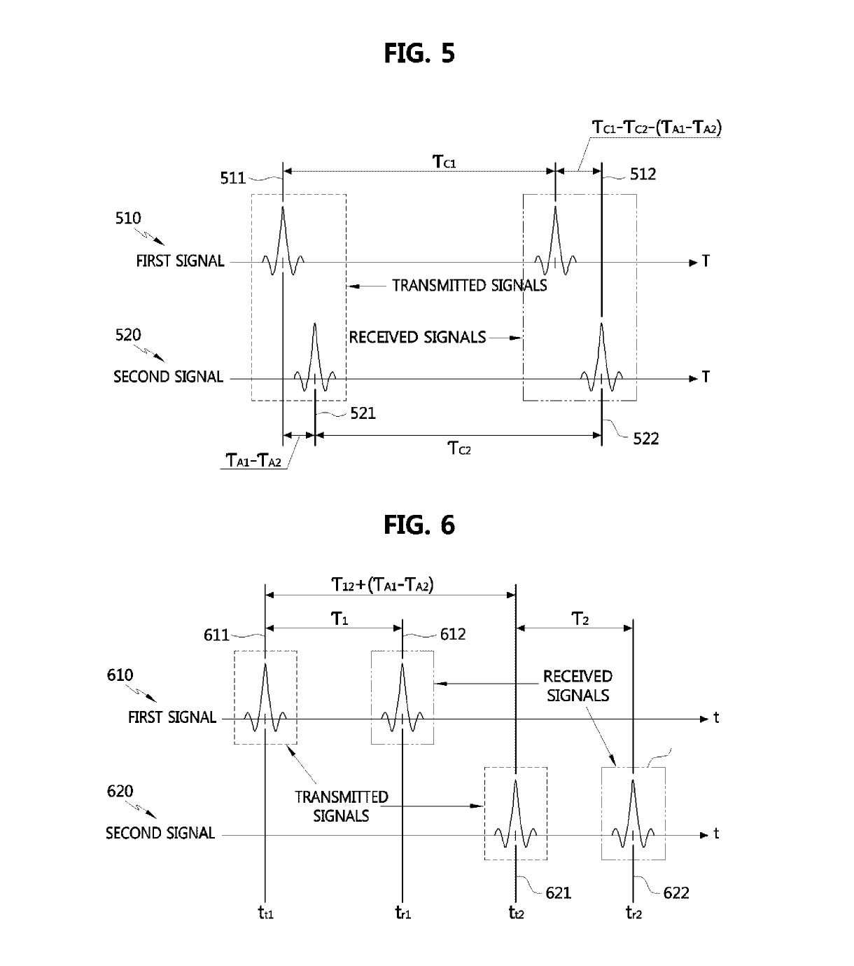

Referring to FIG. 3, horizontal axes of the graph represent the time lapse. That is, a first horizontal axis 310 represents a transmission time 311 in the first signal generating part 101 of the scanning apparatus 100 and an arrival time 312 in the first responding apparatus 110. In addition, a second horizontal axis 320 represents a transmission time 321 in the second signal generating part 102 of the scanning apparatus 100 and an arrival time 322 in the first responding apparatus 110. FIG. 4 and FIG. 5 show transmission times and arrival times of the first and the second signal in the second responding apparatus 120 and the third responding apparatus 130 in the same manner.

As shown in FIG. 3, the first signal generating part 101 transmits the first signal earlier than the second signal generating part 102 with a time difference of τ_{A1}−τ_{A2}. Since τ_{A1}−τ_{A2} becomes a negative value in the case of θ_{A}>0, the second signal generating part 102 is configured to transmit the second signal earlier than the first signal generating part in the case of θ_{A}>0.

The first signal transmitted from the first signal generating part 101 arrives at the first responding apparatus 110 after a transmission delay time τ_{A1} and the second signal transmitted from the second signal generating part 102 arrives at the first responding apparatus 110 after a transmission delay time τ_{A2}.

Considering an error of measuring receiving time of signal, if arrival time difference between the first signal transmitted from the first signal generating part and the second signal transmitted from the second signal generating part is in the predetermined range (range defined by a threshold value which is essentially near 0), the first responding apparatus 110 determines it is in the direction which the scanning apparatus desires to select and transmits a response message to the scanning apparatus.

Secondly, FIG. 4 is a graph to explain signals received in the second responding apparatus.

The first signal 411 transmitted from the first signal generating part 101 arrives 412 at the second responding apparatus 120 after a transmission delay time τ_{B1} and the second signal 420 transmitted from the second signal generating part 102 arrives 422 at the second responding apparatus 120 after a transmission delay time τ_{B2}. Here, τ_{B1}=d_{B1}/ν and τ_{B2}=d_{B2}/ν.

Since θ_{B}>θ_{A}, an equation 3 can be established as follows.

τ_{B1}−τ_{B2}>τ_{A1}−τ_{A2} [Equation 3]

Therefore, in the second responding apparatus 120, the second signal transmitted from the second signal generating part 102 arrives earlier than the first signal transmitted from the first signal generating part 101. Considering an error of measuring receiving time of signal, if arrival time difference between the first signal transmitted from the first signal generating part and the second signal transmitted from the second signal generating part is not in the predetermined range (range defined by a threshold value), the second responding apparatus 120 determines it is not in the direction which the scanning apparatus desires to select and may not transmit a response message to the scanning apparatus.

Thirdly, FIG. 5 is a graph to explain signals received in the third responding apparatus.

As explained above, the first signal generating part 101 transmits the first signal earlier than the second signal generating part 102 with a time difference of τ_{A1}−τ_{A2}.

The first signal transmitted from the first signal generating part 101 arrives at the third responding apparatus 130 after a transmission delay time τ_{C1} and the second signal transmitted from the second signal generating part 102 arrives at the third responding apparatus 130 after a transmission delay time τ_{C2}. Here, τ_{C1}=d_{C1}/ν and τ_{C}=d_{C2}/ν.

Since θ_{C}<θ_{A}, an equation 5 can be established as follows.

τ_{C1}−τ_{C2}<τ_{A1}−τ_{A2} [Equation 4]

Therefore, in the third responding apparatus 130, the first signal transmitted from the first signal generating part 101 arrives earlier than the second signal transmitted from the second signal generating part 102.

Considering an error of measuring receiving time of signal, if arrival time difference between the first signal transmitted from the first signal generating part and the second signal transmitted from the second signal generating part is not in the predetermined range (range defined by a threshold value), the third responding apparatus 130 determines it is not in the direction which the scanning apparatus desires to select and may not transmit a response message to the scanning apparatus.

As explained referring to FIG. 3, FIG. 4 and FIG. 5, it is possible that the only apparatuses positioned in the direction which the scanning apparatus desires to select responds and other apparatuses positioned in other directions do not respond according to the present invention.

However, in the cases of examples shown in FIG. 3, FIG. 4 and FIG. 5, error can be generated in estimating arrival time differences of the received signals when the first signal and the second signal are received simultaneously in time at the responding apparatus, and this error may cause performance degradation.

In order to overcome above-mentioned problem, two kinds of solutions are available as follows. Also, two solutions may be used in the combinational manner for maximizing performance.

1) A solution that the first signal generating part and the second signal generating part transmit the first signal and the second signal with an additional predetermined time difference

FIG. 6 is a conceptual diagram to explain another example method of scanning neighbor apparatuses by using spatial filtering according to the present invention.

The solution, in which the first signal generating part 101 and the second signal generating part 102 transmit the first signal and the second signal with an additional predetermined time difference, is shown in FIG. 6.

Referring to FIG. 6, horizontal axes of the graph represent the time elapse. That is, a first horizontal axis 610 represents a transmission time 611 of the first signal from the first signal generating part 101 of the scanning apparatus 100 and an arrival time 612 of the first signal in the first responding apparatus 110. In addition, a second horizontal axis 620 represents a transmission time 621 of the second signal from the second signal generating part 102 of the scanning apparatus 100 and an arrival time 622 of the second signal in the first responding apparatus 110.

The second signal generating part 102 transmits the second signal at the time of t=tₜ₂ 612 after the first signal generating part 101 transmitted the first signal at the time of t=f_{T1} 611. Here, equation 5 is established as follows.

tₜ₂−tₜ=T₁₂+(τ_{A1}−τ_{A2}) [Equation 5]

Here, T₁₂ is a value which the scanning apparatus 100 and all the responding apparatuses 110, 120, 130 share as an amount of time added to separate arrival times of the first signal and the second signal in responding apparatuses.

Meanwhile, τ_{A1}−τ_{A2} is a value based on the equation 2 according to the direction of each responding apparatus, not a value known to the responding apparatuses.

If T₁₂<0, the second signal generating part 102 transmits the second signal earlier than the first signal generated by the first signal generating part 101.

Each responding apparatus may determine whether itself is located in a direction which the scanning apparatus desires or not based on an equation 6.

T₁₂−(tᵣ₂−tᵣ₁) [Equation 6]

Here, tᵣ₁ represents an arrival time 612 of the first signal transmitted from the first signal generating part 101 in a responding apparatus, and tᵣ₂ represents an arrival time 622 of the second signal transmitted from the second signal generating part 102 in the same responding apparatus.

tᵣ₁ and tᵣ₂ can be represented via an equation 7 and an equation 8 which comprise terms of τ₁, τ₂, τ_{A1}, τ_{A2}, T₁₂, tₜ₁ as follow.

tᵣ₁=tₜ₁+τ₁ [Equation 7]

tᵣ₂=tₜ₁+T₁₂+(τ_{A1}−τ_{A2})+τ₂ [Equation 8]

An equation 9 can be obtained by combining the equation 7, 8, and 6.

T₁₂−(tᵣ₂−tᵣ₁)=(τ₁−τ₂)−(τ_{A1}−τ_{A2}) [Equation 9]

The value of the equation 9 is evaluated to different values depending on the responding apparatus as follows.

The first responding apparatus: the value of the equation 9 becomes 0, since τ₁=τ_{A1} and τ₂=τ_{A2}.

The second responding apparatus: the value of the equation 9 becomes a value greater than 0, since τ_{B}>θ_{A} and so τ₁−τ₂>τ_{A1}−τ_{A2}.

The third responding apparatus: the value of the equation 9 becomes a value less than 0, since θ_{C}<θ_{A} and so τ₁−τ₂<τ_{A1}−τ_{A2}.

Each responding apparatus can determine its direction from the scanning apparatus according to the value of the equation 9. For example, each responding apparatus can know it is located in the left-hand side direction from the direction desired by the scanning apparatus when the value of equation 9 is negative or it is located in the right-hand side direction from the direction desired by the scanning apparatus when the value of equation 9 is positive.

Considering an error of measuring receiving time of signal, when the value of equation 9 is in the predetermined range (range defined by a threshold value), the responding apparatus determines it is located in the direction desired by the scanning apparatus and may transmit a response message to the scanning apparatus. The responding apparatus may not transmit the response message to the scanning apparatus when the value of equation 9 is out of the predetermined range.

2) A solution, in which the first signal and the second signal are signals orthogonal to each other

As another solution for overcoming error of estimating arrival time differences of the received signals when the first signal and the second signal are received simultaneously in time at the responding apparatus, signals which can be separated from each other even when they overlap in time axis can be used for the first signal and the second signal. For example, signals orthogonal to each other in time axis can be used for the first signal and the second signal.

Meanwhile, the present invention can be used for another application for the responding apparatus to determine its relative direction with respect to the 0° direction which is oriented by the scanning apparatus.

For example, suppose θ_{A}=0°, that is θ_{A} is equal to the reference direction oriented by the scanning apparatus (direction of 0°).

In this case, since the first responding apparatus 110 is located in the direction of 0°, d_{A1}=d_{A2} and so τ_{A1}=τ_{A2}.

On the contrary, when θ_{A}=0°, the value of equation 9 in the second responding apparatus 120 becomes τ_{B1}−τ_{B2}. The second responding apparatus 120 can estimate θ_{B} based on equation 10 which is derived from equation 2 as follows.

$${θ}_{B} = {sin}^{- 1} ( \frac{v}{d} ( {τ}_{B 1} - {τ}_{B 2} ) ) \qquad [ Equation 10 ]$$

Also, the third responding apparatus can estimate θ_{C} based on equation 11 which is derived from equation 2 as follows.

$${θ}_{C} = {sin}^{- 1} ( \frac{v}{d} ( {τ}_{C 1} - {τ}_{C 2} ) ) \qquad [ Equation 11 ]$$

As explained above, the present invention can be applied to the application for the responding apparatus to determine its direction from the reference direction 0° which is oriented by the scanning apparatus in addition to the application that the scanning apparatus selects the responding apparatus in the desired direction.

Meanwhile, a case, in which the first signal and the second signal are transmitted to responding apparatuses through multi-path environment, may be supposed. When the multi-path environment exists between the scanning apparatus and the responding apparatuses, responding apparatus may receive multiple instances of signals although the scanning apparatus transmits the signals only once.

For this case, measuring arrival time of signal may be based on only the received signal instance which arrives first. In other words, the first received signal instance can be supposed to be transmitted through a line-of-sight (LOS) path. If the first received signal instance is not through a LOS path, there may be error in estimation on the distance between the scanning apparatus and the responding apparatus.

In the example explained above, responding apparatuses are configured to determine whether to be located in the direction desired by the scanning apparatus or not and whether to respond to the scanning apparatus or not based on information obtained from received signals.

In this case, there may be two problems we can consider as follow.

First, when all the responding apparatuses do not have unified criteria for determining whether or not each of them is located in the desired direction, a problematic situation that an apparatus, which is not a really desired apparatus, responds to the scanning apparatus due to an error of estimating arrival time difference can occur.

Second, another problematic situation that none of all the responding apparatuses respond to the scanning apparatus due to an error of estimating arrival time difference can occur.

In order to resolve above-mentioned problems, there can be an alternative solution that the scanning apparatus determines a desired responding apparatus instead of each responding apparatus which received the first and the second signal determining whether it is in the desired direction or not. The solution is explained as follows.

For example, the scanning apparatus is supposed not to know identifiers of responding apparatuses when the scanning apparatus desires to scan responding apparatuses in the specific direction.

At first, the scanning apparatus may transmit the first signal and the second signal for spatial filtering according to the present invention.

Next, the responding apparatuses receive the first signal and the second signal from the scanning apparatus and transmit response message including an arrival time difference between the first and the second signal or a result of the Equation 9 to the scanning apparatus. At this time the identifier of each responding apparatus may be transmitted to the scanning apparatus together.

Next, the scanning apparatus analyzes the arrival time difference between the first and the second signal or the result of the Equation 9 in the response messages transferred from responding apparatuses, determines which response message is from the apparatus located in the desired direction, and can communicate with the apparatus located in the desired direction by using the identifier included in the response message.

Although the above-described solution has a disadvantage of increased communication data caused by response messages for all the responding apparatuses, the solution has advantage of resolving the two problems as explained above.

Meanwhile, a hybrid method combining the first solution and the second (alternative) solution may be possible.

For instance, when a responding apparatus determines that there is a possibility that it is located in the desired direction of the scanning apparatus, the responding apparatus may transmit the response message including the arrival time difference between the first and the second signal or the result of the Equation 9 to the scanning apparatus. Although all the responding apparatuses, which have received signals transmitted from the scanning apparatus, respond to the scanning apparatus with the response message including the arrival time difference between the first and the second signal or the result of the Equation 9 in the second solution, the only responding apparatuses, which have determined that it is possible that they are located in the desired direction, respond to the scanning apparatus with the response message including the arrival time difference between the first and the second signal or the result of the Equation 9 in the hybrid solution.

That is, when a plurality of responding apparatuses are located in the desired direction, the scanning apparatus may select the most desirable responding apparatus based on the above-mentioned information included in the response message as a target apparatus.

Meanwhile, for the more accurate result, the scanning apparatus may provide the user with a list of responding apparatuses which transmitted response messages to the scanning apparatus when the scanning apparatus receives a plurality of response messages, and the user may finally select the responding apparatus in the list as a desired (target) apparatus.

The provisioning of the list of responding apparatuses and making the user select the desired apparatus in the list may be applied to the first, the second, and the hybrid solution.

Composition of Scanning Apparatus According to the Present Invention

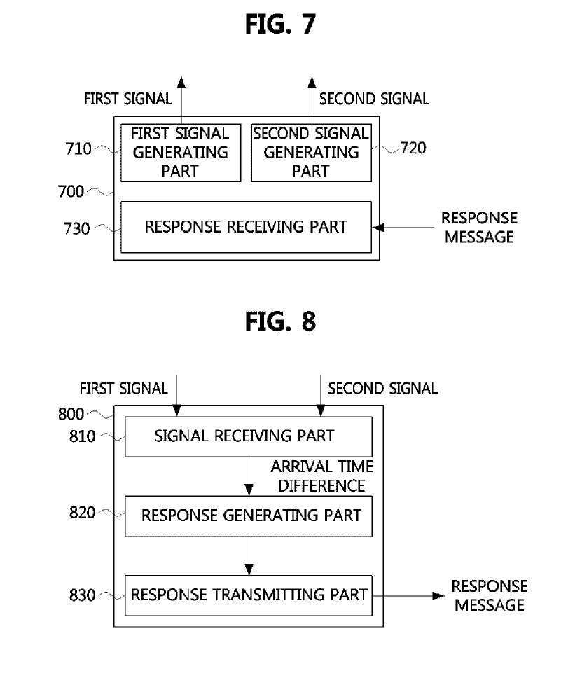

FIG. 7 is a block diagram to explain a composition of scanning apparatus using spatial filtering according to the present invention.

Referring to FIG. 7, an example embodiment of scanning apparatus according to the present invention may comprise the first signal generating part 710, the second signal generator 720, and the response receiving part 730.

The first signal generating part 710 is a component generating the first signal and the second signal generating part 720 is a component generating the second signal.

The first signal generating part 710 is positioned in predetermined distance from the second signal generating part 720. In other words, the generation point of the first signal is positioned in predetermined distance from the generation point of the second signal.

The first signal generating part 710 and the second signal generating part 720 may comprise transducers when the first signal and the second signal are acoustic signals.

The first signal and the second signal may be generated with a predetermined time difference and the predetermined time difference may be determined based on the equation 2 in consideration of the direction which is desired to scan by the scanning apparatus.

Signals orthogonal to each other may be applied for the first signal and the second signal, and the predetermined time difference of the first and the second signal may include additional amount of time (T₁₂) shared by the scanning apparatus and the responding apparatuses.

There may be two kinds of methods for receiving the response from the responding apparatuses.

A first method is that the responding apparatus, which determined it is a target apparatus when the arrival time difference of the first signal and the second signal is in a predetermined range (in other words, less than a threshold value), provides the response message to the scanning apparatus.

In the first method, when the additional amount of predetermined time is included in the transmission time difference, responding apparatuses may be configured to determine whether or not to respond to the scanning apparatus by considering the additional amount of time in the arrival time difference of the first and second signal based on the equation 9.

A second method is that the responding apparatus generates and transmits a response message, which includes a value based on the arrival time difference of the first and second to signal or based on the result value of the equation 9 and an identifier of itself, to the scanning apparatus.

In the first method, the responding apparatus determines whether it is the target apparatus in the desired direction or not and transmits the response message to the scanning apparatus only when it is determined to be the target apparatus. In other words, the responding apparatus determines its direction by itself in the first method.

On the other hand, in the second method, the responding apparatus does not determine whether to or not to respond to the scanning apparatus and all the responding apparatuses, which receive the first signal and the second signal, transmit response messages to the scanning apparatus. As explained above, the second method is for the scanning apparatus to determine which responding apparatus is in the direction desired by the scanning apparatus. The second method can resolve above-mentioned problematic situations that a false apparatus responds to the scanning apparatus or none of all the responding apparatuses respond to the scanning apparatus due to an error of estimating arrival time difference.

When the first method is used, we can have advantage of decreasing the amount of response messages transmitted from the responding apparatuses. When the second method is used, we can have advantage of resolving problems due to an error of estimating arrival time difference.

Meanwhile, the hybrid method which combines the first method and the second method, which has been already explained, may be used.

The response receiving part 730 is a component which enables for the scanning apparatus to receive the response message, composed by one of above-mentioned two methods, from the responding apparatus, may be a communication unit equipped in the scanning apparatus. For example, the response receiving part 730 may be configured to communicate with the responding apparatuses by one of various wireless communications technologies such as Bluetooth, IEEE 802.11, and ZigBee, etc.

Composition of Responding Apparatus According to the Present Invention

FIG. 8 is a block diagram to explain a composition of responding apparatus using spatial filtering according to the present invention.

A responding apparatus shown in FIG. 8 means an apparatus transmitting a response message to the scanning apparatus based on spatial filtering based on the first signal and the second signal generated from the scanning apparatus explained above.

Referring to FIG. 8, an example embodiment of the responding apparatus according to the present invention may include a signal receiving part 810, a message generating part 820, and a response transmitting part 830.

The signal receiving part 810 is a component which receives the first signal and the second signal generated from a counterpart apparatus (a scanning apparatus explained in FIG. 7).

As explained above, the first signal and the second signal may be generated with a predetermined time difference in the scanning apparatus, the predetermined time difference is configured by the scanning apparatus in consideration of a direction which the scanning apparatus desires to select based on the equation 2. Also, the first signal and the second signal may be generated with a predetermined distance in the scanning apparatus.

The first signal and the second signal may be signals orthogonal to each other. The predetermined time difference of the first and second signal generation may include an additional amount of time shared by the scanning apparatus and the responding apparatus (For example, T₁₂).

The message generating part 820 is a component generating a response message based on an arrival time difference of the first and the second signal.

There may be three methods (the first method, the second method, and the hybrid method which combines the first method and the second method) to generate the response message in the message generating part 820.

The first method is that the responding apparatus provides the response message to the scanning apparatus when the responding apparatus determines itself as a apparatus which should responds if the arrival time difference of the first and the second signal is in a predetermined range (less than a threshold value). In other words, if the arrival time difference is not in the predetermined range (equal to or greater than a threshold value), the message generating part 820 does not generate the response message.

In this case, when transmission time difference of the first and the second signal includes the additional amount of time (T₁₂) shared by the scanning apparatus and the responding apparatus, the responding apparatus is configured to determine whether to respond or not based on the arrival time difference and the additional amount time (namely, the value of the equation 9).

The second method is that the responding apparatus composes the response message including a value based on the arrival time difference of the first and second signal or based on the result value of the equation 9 and an identifier of itself and transmits the composed response message to the scanning apparatus.

The difference between the first method and the second method is which apparatus (the scanning apparatus or the responding apparatus) determines whether the responding apparatus is in the desired direction or not. The detail of the difference was explained above.

Meanwhile, the hybrid method which combines the first method and the second method, which has been already explained, may be used.

The response transmitting part 830 is a component which enables for the responding apparatus to transmit the response message to the scanning apparatus as a component corresponding to the response receiving part 730 of the scanning apparatus in FIG. 7.

The response transmitting part 830 may be a communication unit equipped in the responding apparatus. For example, the response transmitting part 830 may be configured to communicate with the scanning apparatuses by one of various wireless communications technologies such as Bluetooth, IEEE 802.11, and ZigBee, etc.

According to the present invention, it becomes possible to select an apparatus located in a specific direction among neighbor apparatuses by using spatial filtering based on a plurality of signals.

In addition, one of other example embodiments according to the present invention enables an apparatus only in the specific direction to be configured to respond by using spatial filtering, and so the amount of communication between apparatuses may be decreased in the case that a plurality of neighbor apparatuses exist.

While example embodiments of the present invention and their advantages have been described in detail, it should be understood that various changes, substitutions, and alterations may be made herein without departing from the scope of the invention.

What is claimed is:

1. A scanning apparatus for receiving a response from a counterpart apparatus by using spatial filtering, the scanning apparatus comprising:
a first signal generating part generating a first signal;
a second signal generating part generating a second signal, wherein the second signal generating part is positioned in a generation distance from the first signal generating part;
a response receiving part receiving a response message based on arrival time difference between the first signal and the second signal in the counterpart apparatus from the to counterpart apparatus.

2. The apparatus of claim 1, wherein the first signal and the second signal are acoustic signals.

3. The apparatus of claim 1, wherein the first signal and the second signal are generated with a predetermined transmission time difference.

4. The apparatus of claim 3, wherein the first signal is a signal orthogonal to the second signal.

5. The apparatus of claim 3, wherein the predetermined transmission time difference is configured to include a predetermined amount of time shared by the scanning apparatus and the counterpart apparatus.

6. The apparatus of claim 3, wherein the predetermined transmission time difference is configured based on a position of the counterpart apparatus from which the scanning apparatus desires to receive the response message.

7. The apparatus of claim 6, wherein the response message from the counterpart apparatus is received when the arrival time difference between the first signal and the second signal in the counterpart apparatus is less than a predetermined value.

8. The apparatus of claim 3, wherein the response message from the counterpart apparatus comprises a value based on the arrival time difference between the first signal and the second signal and identifier of the counterpart apparatus.

9. A responding apparatus responding by using spatial filtering based on a plurality of received signals, the responding apparatus comprising:
a signal receiving part receiving a first signal and a second signal from a scanning apparatus, wherein the second signal is generated in a predetermined distance from a generation position of the first signal;
a response generating part generating a response message based on arrival time difference between the first signal and the second signal; and
a response transmitting part transmitting the response message to the scanning apparatus.

10. The apparatus of claim 9, wherein the first signal and the second signal are acoustic signals.

11. The apparatus of claim 9, wherein the first signal and the second signal are generated with a predetermined transmission time difference.

12. The apparatus of claim 11, wherein the first signal is a signal orthogonal to the second signal.

13. The apparatus of claim 11, wherein the predetermined transmission time difference is configured to include a predetermined amount of time shared by the scanning apparatus and the responding apparatus.

14. The apparatus of claim 11, wherein the predetermined transmission time difference is configured based on a position of the responding apparatus from which the scanning apparatus desires to receive the response message.

15. The apparatus of claim 11, wherein the response message is generated and transmitted when the arrival time difference between the first signal and the second signal in the responding apparatus is less than a predetermined value.

16. The apparatus of claim 11, wherein the response message to the scanning apparatus comprises a value based on the arrival time difference between the first signal and the second signal and identifier of the responding apparatus.
